(19) United States
(12) Patent Application Publication
(10) Pub. No.: US 2021/0312284 A1
(43) Pub. Date: Oct. 7, 2021

(54) SYSTEM AND METHOD FOR VALIDATION AND CORRECTION OF REAL-TIME SENSOR DATA FOR A PLANT USING EXISTING DATA-BASED MODELS OF THE SAME PLANT

(71) Applicant: Siemens Aktiengesellschaft, Munich (DE)

(72) Inventors: Arindam Dasgupta, Avon, CT (US); Feipeng Zhao, Lawrenceville, NJ (US); Charles A. Carlson, Jr., Chuluota, FL (US); Chao Yuan, Plainsboro, NJ (US); Amit Chakraborty, East Windsor, NJ (US)

(21) Appl. No.: 17/261,040

(22) PCT Filed: Aug. 23, 2018
(86) PCT No.: PCT/US2018/047638

§ 371 Date: Jan. 18, 2021

(51) Int. Cl. G06N 3/08; G06N 3/04

(52) U.S. Cl. CPC G06N 3/08; G06N 3/0454

(57) ABSTRACT

A system for verification of the output of a sensor includes an industrial system comprising a plurality of sensors, one of the plurality of sensors being a target sensor, a plurality of machine learning networks, each machine learning network connecting a plurality of driving sensors associated with the target sensor and trained using simulation data. a selected machine learning network from the plurality of machine learning networks having an output representative of the target sensor, the selected machine learning network being trained with real-time data from the industrial plant and a processor for comparing an output of the selected machine learning network to a real output of the target sensor. Based on the comparison, the real sensor output is provided as final output when the values match, and the estimated value is output when the values do not match and the sensor output is flagged as an error.

### TECHNICAL FIELD

This application relates to industrial systems. More particularly, this application relates to verification and validation of sensor data in industrial systems.

### BACKGROUND

Modern industrial systems rely on sensors associated with system components to provide operational data about the components. Abnormal readings from sensors may indicate a problem with a component provided the information from the sensor is accurate. However, it is possible that the sensor itself is faulty and providing inaccurate readings. Today this problem is addressed in several ways. For example, sensors are regularly calibrated and maintained to ensure their readings are true. This is a time-consuming and costly process. Another way to validate sensor information is to cross-correlate the sensors at any given instant in time and identify any sensor whose value is outside the bounds of understood physical laws based on related sensors. However, this method is flawed in that some level of noise on all sensors can affect the conclusion and even if the sensor reading is identified to be faulty, it is difficult to correct the sensor to an acceptable range.

### SUMMARY

A system for verification of the output of a sensor in an industrial plant includes an industrial system comprising a plurality of sensors, wherein one of the plurality of sensors is a target sensor, a plurality of machine learning networks, each machine learning network connecting a plurality of driving sensors associated with the target sensor and trained using simulation data. a selected machine learning network from the plurality of machine learning networks having an output representative of the target sensor, the selected machine learning network being trained with real-time data from the industrial plant and a processor for comparing an output of the selected machine learning network to a real output of the target sensor. According to embodiments the system may include a computer processor configured to construct a machine learning network comprising nodes representative of a plurality of driving sensors, run a physics simulation of the industrial system on the machine learning network to produce an estimated output of the target sensor, iteratively remove nodes from the machine learning network one-by-one and generate a new estimated output of the target sensor, determine if the removed node has an effect on the output of the target sensor and replace the removed node if it has an effect on the estimated output of the target node and omit the removed node from the next iteration if the removed node has no effect on the estimated output of the target node.

In some embodiments, the plurality of machine learning networks are artificial neural networks. According to some embodiments, the industrial system comprises a plurality of components, each component having at least one sensor.

The system may further have a first component that is associated with a second component by a relationship between a first sensor of the first component and a second sensor of the second component. Further, the target sensor may be associated with the first component and at least one of the driving sensors may be associated with the second component.

According to certain embodiments, a computer processor is configured to provide an output of the target sensor, wherein the computer processor outputs a real-time output value from the target sensor when the real-time output value matches the estimated output value of the target sensor from the selected machine learning network.

In other embodiments an error counter monitors a number of errors produced by the target sensor, the error counter increments the number of errors each time the real-time output value of the target sensor does not match the estimated output value of the target sensor. A notification generator may be included to produce a message when the number of errors reaches or exceeds a pre-determined number of errors. The notification generator is configured to identify the target sensor and suggest a course of corrective action. The course of action may include re-calibrating the target sensor or replace the target sensor.

A method of validating a sensor output value in an industrial system, includes identifying from a plurality of sensors, one target sensor, identifying at least one driving sensor from the plurality of sensors, the at least one driving sensor producing output indicative of an effect on the target sensor, defining a plurality of machine learning networks based on the identified at least one driving sensor, training the plurality machine learning networks on data from a physics-based simulation of the industrial system, selecting a selected machine learning network from the plurality of machine learning networks that produces an accurate estimate of an output of the target sensor and training the selected machine learning network using real-time data generated by the industrial system.

The method may further include removing driving sensors one-by-one from each of the plurality of machine networks to produce a candidate machine learning network, simulating an output of the target sensor using the candidate machine learning network, determining if removal of the driving sensor to determine an effect on the simulated output of the target sensor and ranking the candidate machine learning network based on the determined effect, wherein the selection of the selected machine learning network is based on the ranking. The comparison may be based on a percentage of the target sensor output value in some embodiments or based on a precision tolerance value of the target sensor in other embodiments. According to embodiments, a user is notified when a number of errors reaches a given threshold number of errors. The notification may notify the user to replace the target sensor or to re-calibrate the target sensor.

According to some embodiments, the selected machine learning network is trained using most recent real-time data, wherein older system data is removed from the training set as the more recent real-time data is received.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an industrial system illustrating multiple input and output values generated by sensors installed in the system according to aspects of embodiments of the present disclosure.

FIG. 2 is a process flow diagram for a method of validating sensor data in a system according to aspects of embodiments of the present disclosure.

FIG. 3 is a block diagram of a system for validating sensor data in a system according to aspects of embodiments of the present disclosure.

FIG. 4 is a block diagram of a computer system that may be used to implement embodiments of the present disclosure.

### DETAILED DESCRIPTION

Modern day power plants, whether they are combined cycle or simple cycle, are equipped with several hundreds of sensors to record the state of the plant at any given instant. This allows for the performance of the plant to be monitored, for control of the plant, and for early detection of faults of the plant and the reason for the fault determined. Usually this data is retained either on-site by the operator or transmitted back to the original equipment manufacturer (OEM) or both for subsequent analysis and use. But, having so many sensors operating in a harsh environment often results in sensor malfunction resulting in erroneous data being recorded. This is a challenge because the data analysis needs to identify whether an abnormal value is due to a faulty sensor or actual malfunction of a component. Misinterpretation of the anomalous data can lead to incorrect decisions, improper control actions and may result in serious impediments to operation and can even cause damage to components. To avoid unnecessary shutdown, a system must be able to distinguish between sensor failure and system malfunction. This distinction must be made at a level above the machine control level, such as by a supervisory controller. Furthermore, if readings are corrupted by noise and degraded sensor performance, the system must filter out noise and effects of sensor failures.

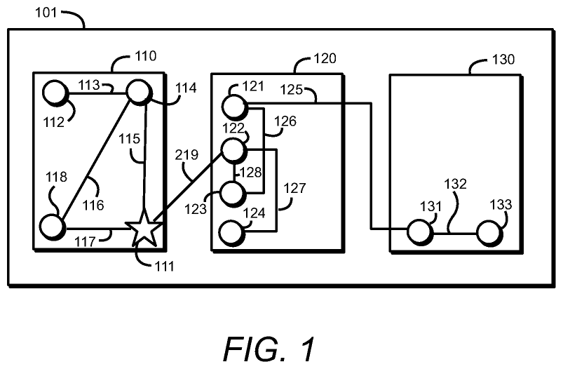

FIG. 1 illustrates a system having a network of sensors according to embodiments of this disclosure. The system 101 may include many components. System 101 includes component 110, component 120 and component 130. Each component may be associated with one or more sensors. For example, component 110 may be associated with sensors 112, 114, 118 and 111. Component 120 is associated with sensors 121, 122, 123 and 124. Component 130 is associated with sensors 131 and 133.

Sensors measure characteristics of the system 101 relating to the component with which the sensor is associated. For example, a motor may include a speed sensor and a temperature sensor. The speed sensor is configured to measure and monitor the rotational velocity of the motor shaft. A temperature sensor is situated in a proximal to the motor and measures and monitors the temperature of the surrounding area. Temperature may be monitored of a motor component as the motor operates or may measure ambient temperature of a location near the motor. Other sensors may be included that are associated with a given component that perform various functions. Sensors may be in communication with other mechanisms, such as switches or actuators that allow for control of components 110, 120, 130 making up the system 101.

Sensors may be characterized as having relationships with other sensors or mechanisms. In the preceding example regarding a motor, the temperature sensor may detect an abnormally high operating temperature. To reduce the operating temperature, a control signal may be provided to a speed control to reduce the motor speed and reduce its operating temperature. The control operation will be detectable via the speed sensor which should indicate a reduced motor speed. Other relationships may be contemplated between various sensors and mechanisms. Relationships may exist as one-to-one, one-to-many, many-to-one or many-to-many. Referring to FIG. 1, relationships are indicated by lines connecting one or more sensors. For example, relationship 113 connects sensor 112 and 114. Relationship 116 connects sensors 118 and 114. Relationship 115 connects sensor 111 and sensor 114 and relationship 117 connects sensors 111 and 118.

Relationships may also link different components of system 101. For example, relationship 219 connects sensor 111 associated with component 110 and sensor 122 associated with component 120. Similarly, relationship 125 connects sensor 121 associated with component 120 and sensor 131 associated with component 130. Additional relationships 126, 127 and 132 connect sensors 121, 123, 122, 124 and 131 and 133, respectively.

When considering the accuracy of a sensor's measured value, a sensor may be isolated for consideration. Thus, one sensor may be considered the target sensor. Referring to FIG. 1, sensor 111 may be considered the target sensor, as is indicated as the target sensor by the illustrated star shape. Target sensor 111 is connected to other sensors 114 by relationship 115, sensor 118 by relationship 117 and to sensor 122 and component 2 by relationship 219. Target sensor 111 is further affected by indirect relationships that affect sensors directly connected with the target sensor 111. For example, sensor 122 is directly connected to target sensor 111 by relationship 219. However, a chain of relationships associated with sensor 122 also bring considerations of the effects of sensor 123 through relationship 128, which is further connected to sensor 121 via relationship 126. Sensor 121 is further connected to sensor 131 through relationship 125 and ultimately, sensor 133 through relationship 132. Viewing the system in this way, it is conceivable that the target sensor 111 may be affected by not only directly connected sensors 118, 114 and 122, but through other indirectly connected sensors. As will be described in greater detail below, each factor that may affect the output of the target sensor 111 is considered to determine a network for machine learning that most accurately can predict an appropriate value for the target sensor 111 based on either simulated or actual data associated with the other sensors in the system 101.

To address these goals, a machine learning-based data model for a power plant is proposed to be the basis for validating the sensor readings and make corrections if required. The following process is proposed:

According to embodiments described herein, estimation of sensor values is achieved by defining machine learning modes that predict the values expected from target sensors. In some embodiments, a model like an Artificial Neural Network (ANN) may be used to predict the value of each sensor based on the values of other sensors. Other predictive methodologies may also be used. Because complex systems may involve hundreds of sensors to be considered, it is important to find a set of sensors that adequately and accurately predicts the output value of the target sensor. This is accomplished by training the machine-learning models using values obtained from a physics-based simulation of the plant or industrial system. The simulation data is used to train different ANNs that connect different “driving” sensors bearing relationships to the target sensor 111 and then systematically eliminating combinations of one or more inputs that show little or no impact when excluded from the simulation. One result is to produce an error rate of prediction may be established and used to characterize when a target sensor 111 is causing enough errors to require some remedial action to address recurring problems with the target sensor 111.

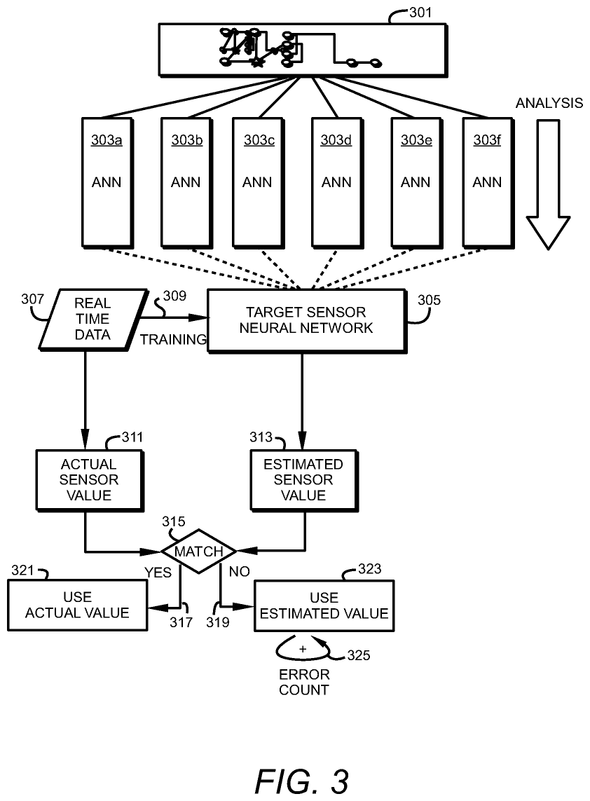

FIG. 3 is a block diagram of a system for selecting a machine learning network that is adapted to predict the value of the target sensor. The system 301 includes an interconnected series of sensors and actuators and controls. A plurality of machine-learning networks 303a through 303f, for example ANNs, are defined which are deemed to be relevant to the target sensor. Analysis is performed by systematically removing various sensors from each network 303a through 303f to determine if the removed sensors have a noticeable impact on the estimated value of the target sensor. Once the unnecessary sensors are removed, the network 303 that most efficiently predicts the output value of the target sensor is selected 305.

Once the selected network 305 is selected, machine learning may be performed by training 309 the selected network 305 using real-time data 307 generated by the system 301 or industrial system. Accordingly, the real time data 307 attributable to the relevant sensors identified in the selected network 305 is used for training 309 the selected network 305. Once trained with real-time data 307, the selected network 305 will generate an estimated value for the target sensor 313. Meanwhile, operation of the system 301 will generate real-time data 307 including an actual output value produced by the physical target sensor 311.

To verify the output value of the target sensor 311, the actual sensor value 311 is compared 315 to the estimate value 313. If the estimated sensor value 313 is found to be within a pre-determined threshold of the actual sensor value 311, the estimate 313 is considered to match the actual sensor value 311. If, on the other hand, the estimated sensor value 313 falls outside a pre-determined threshold of the actual sensor value 311, then the actual sensor value 311 is considered not to match the estimate 313. The threshold may be determined by many manners, including a precision tolerance of the target sensor, or as a percentage of the sensor value deemed to be acceptable for operation of the system 301. Other methods of determining an acceptable threshold will be evident to persons of skill in the art.

When the actual sensor value 311 is determined as a match 317 to the estimated value 313, the actual sensor value 311 is deemed reliable and is used 321 as the output of the sensor. If the actual sensor value 311 is determined not to match 319 the estimate 313, then the estimated value is used 323 and the target sensor is flagged as producing an error. For each non-matching value produced by the target sensor, an error count is incremented 325. Once the target sensor produces too many errors as determined by the system operator, a notification or warning may be generated to notify the operator that remediation is necessary for the target sensor. For example, the warning message may indicate that the target sensor requires calibration, or possible replacement.

Through the system described in FIG. 3, improvements to conventional sensor verification systems are achieved. Furthermore, the operation of machine learning networks is improved by identifying the most relevant data points for estimating the output value of a target sensor. This results in faster and more efficient training and calculation of estimated sensor values. The collection and processing of non-relevant input data is eliminated, while producing a more accurate and reliable estimated sensor value. In addition, the production of a more accurate estimate allows for training the network with actual data to produce reliable real-time sensor value estimates that can be compared with actual sensor outputs. The selected network will adjust to variations in system states and produce an estimate value that is appropriate to the state of the system at the time the actual sensor output is created.

The process is dynamic, in that the ANNs are continuously upgraded as additional data 309 comes in. Additionally, new data is weighted more than old data and eventually old data is completely excluded. Thus, using real-time data 307 provides a sliding window of training data 309 that more closely reflects the most current system condition. This helps capture the degradation of the machine as well as the sensors.

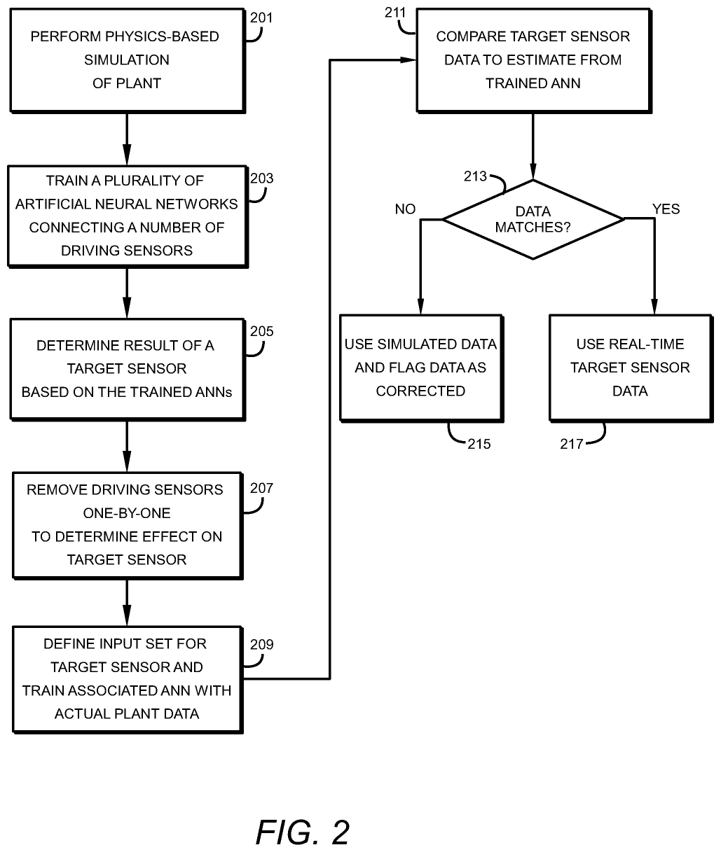

Referring now to FIG. 2, a process flow diagram is provided that illustrates a method of verifying sensor output according to aspects of embodiments of the present disclosure. First, a physics-based simulation of the plant or system is run 201 to create data that is used to train a plurality of artificial neural networks 203. The neural networks may be many types of network that allows for machine learning. Each neural network is representative of a group of driving sensors that affect the output of a target sensor of interest. When the ANNs are trained, a result of an output value for the target sensor is determined 205. For each of the plurality of ANNs, the driving sensors making up the network are removed one-by-one to determine each driving sensor's effect on the target sensor output value 207. When the sensors that do not affect the target sensor are removed, an input set for the target sensor is determined and the resulting network of driving sensors is trained using actual plant data 209. Actual target sensor values from the real-time operation of the system is compared to an estimated sensor value generated by the network trained with the real-time system data 211. The estimated value is compared to the actual sensor output value to determine if the data matches 213. If the estimate matches the actual sensor value, the sensor is considered reliable and the sensor value is used as output 217. If the estimate does not match the actual target sensor output value, then the simulated data is used as output and is flagged to indicate there was an error with the target sensor 215.

The method is advantageous over other methods because prediction of sensor values does not require deterministic solution of equations (physics laws) describing plant processes and can be accomplished instantaneously using preexisting trained models. This method is more amenable to Edge Analytics and can be deployed from real-time local computing nodes that are also collecting the data, because computing power and memory required for prediction is low. The computationally intensive activity occurs in the training phase in a more centralized facility. The results of the prediction are more accurate because they are specific to the particular machine and captures its true characteristics (e.g., field tuning degradation, etc.) as opposed to an as-designed set of values.

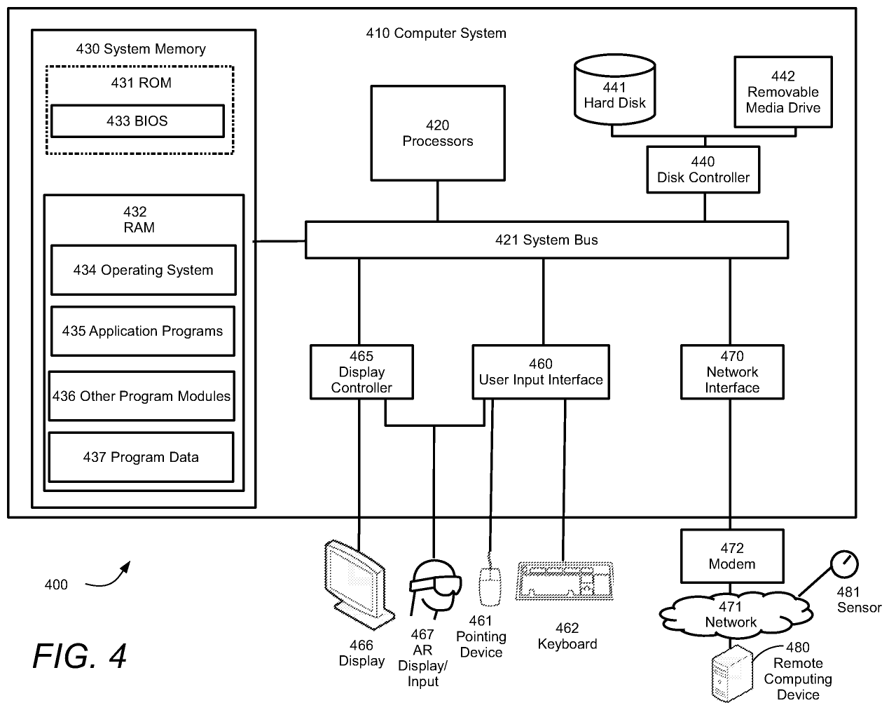

FIG. 4 illustrates an exemplary computing environment 400 within which embodiments of the invention may be implemented. Computers and computing environments, such as computer system 410 and computing environment 400, are known to those of skill in the art and thus are described briefly here.

As shown in FIG. 4, the computer system 410 may include a communication mechanism such as a system bus 421 or other communication mechanism for communicating information within the computer system 410. The computer system 410 further includes one or more processors 420 coupled with the system bus 421 for processing the information.

The processors 420 may include one or more central processing units (CPUs), graphical processing units (GPUs), or any other processor known in the art. More generally, a processor as used herein is a device for executing machine-readable instructions stored on a computer readable medium, for performing tasks and may comprise many combinations thereof, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with many other processors enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 4, the computer system 410 also includes a system memory 430 coupled to the system bus 421 for storing information and instructions to be executed by processors 420. The system memory 430 may include computer readable storage media in the form of volatile and/or nonvolatile memory, such as read only memory (ROM) 431 and/or random-access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application programs 435, other program modules 436 and program data 437.

The computer system 410 also includes a disk controller 440 coupled to the system bus 421 to control one or more storage devices for storing information and instructions, such as a magnetic hard disk 441 and a removable media drive 442 (e.g., floppy disk drive, compact disc drive, tape drive, and/or solid-state drive). Storage devices may be added to the computer system 410 using an appropriate device interface (e.g., a small computer system interface (SCSI), integrated device electronics (IDE), Universal Serial Bus (USB), or FireWire).

The computer system 410 may also include a display controller 465 coupled to the system bus 421 to control a display or monitor 466, such as a cathode ray tube (CRT) or liquid crystal display (LCD), for displaying information to a computer user. The computer system includes an input interface 460, and one or more input devices, such as a keyboard 462 and a pointing device 461, for interacting with a computer user and providing information to the processors 420. The pointing device 461, for example, may be a mouse, a light pen, a trackball, or a pointing stick for communicating direction information and command selections to the processors 420 and for controlling cursor movement on the display 466. The display 466 may provide a touch screen interface which allows input to supplement or replace the communication of direction information and command selections by the pointing device 461. In some embodiments, an augmented reality device 467 that is wearable by a user, may provide input/output functionality allowing a user to interact with both a physical and virtual world. The augmented reality device 467 is in communication with the display controller 465 and the user input interface 460 allowing a user to interact with virtual items generated in the augmented reality device 467 by the display controller 465. The user may also provide gestures that are detected by the augmented reality device 467 and transmitted to the user input interface 460 as input signals.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium, such as a magnetic hard disk 441 or a removable media drive 442. The magnetic hard disk 441 may contain one or more datastores and data files used by embodiments of the present invention. Datastore contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to media that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

The computing environment 400 may further include the computer system 410 operating in a networked environment using logical connections to one or more remote computers, such as remote computing device 480. Remote computing device 480 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 480). In some systems, sensors 481 may be attached to components of the system to measure states of the components. Sensor 481 may communicate information and measurement values to network 471 for additional processing. The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A system for verification of the output of a sensor in an industrial plant comprising:
an industrial system comprising a plurality of sensors, wherein one of the plurality of sensors is a target sensor;
a plurality of machine learning networks, each machine learning network connecting a plurality of driving sensors associated with the target sensor and trained using simulation data;
a selected machine learning network from the plurality of machine learning networks having an output representative of the target sensor, the selected machine learning network being trained with real-time data from the industrial plant;
a processor for comparing an output of the selected machine learning network to a real output of the target sensor.

2. The system of claim 1, further comprising:
a computer processor configured to:
construct a machine learning network comprising nodes representative of a plurality of driving sensors;
run a physics simulation of the industrial system on the machine learning network to produce an estimated output of the target sensor;
iteratively remove nodes from the machine learning network one-by-one and generate a new estimated output of the target sensor;
determine if the removed node has an effect on the output of the target sensor; and
replace the removed node if it has an effect on the estimated output of the target node and omit the removed node from the next iteration if the removed node has no effect on the estimated output of the target node.

3. The system of claim 1, wherein the plurality of machine learning networks are artificial neural networks.

4. The system of claim 1, wherein the industrial system comprises:
a plurality of components, each component having at least one sensor.

5. The system of claim 4, wherein a first component is associated with a second component by a relationship between a first sensor of the first component and a second sensor of the second component.

6. The system of claim 5, wherein the target sensor is associated with the first component and at least one of the driving sensors is associated with the second component.

7. The system of claim 1, further comprising:
a computer processor configured to provide an output of the target sensor, wherein the computer processor outputs a real-time output value from the target sensor when the real-time output value matches the estimated output value of the target sensor from the selected machine learning network.

8. The system of claim 7, further comprising:
an error counter for monitoring errors produced by the target sensor, the error counter configured to increment the number of errors each time the real-time output value of the target sensor does not match the estimated output value of the target sensor.

9. The system of claim 8, further comprising:
a notification generator configured to produce a message when the number of errors reaches or exceeds a pre-determined number of errors.

10. The system of claim 9, wherein the notification generator is configured to identify the target sensor and suggest a course of corrective action.

11. The system of claim 10, wherein the course of action is to re-calibrate the target sensor.

12. The system of claim 11, wherein the course of action is to replace the target sensor.

13. A method of validating a sensor output value in an industrial system, comprising:
identifying from a plurality of sensors, one target sensor;
identifying at least one driving sensor from the plurality of sensors, the at least one driving sensor producing output indicative of an effect on the target sensor;
defining a plurality of machine learning networks based on the identified at least one driving sensor;
training the plurality machine learning networks on data from a physics-based simulation of the industrial system;
selecting a selected machine learning network from the plurality of machine learning networks that produces an accurate estimate of an output of the target sensor; and
training the selected machine learning network using real-time data generated by the industrial system.

14. The method of claim 13, further comprising:
removing driving sensors one-by-one from each of the plurality of machine networks to produce a candidate machine learning network;
simulating an output of the target sensor using the candidate machine learning network;
determining if removal of the driving sensor to determine an effect on the simulated output of the target sensor; and
ranking the candidate machine learning network based on the determined effect, wherein the selection of the selected machine learning network is based on the ranking.

15. The method of claim 13, further comprising:
comparing is based on a percentage of the target sensor output value;

16. The method of claim 13, wherein the comparison is based on a precision tolerance value of the target sensor.

17. The method of claim 13, further comprising:
notifying a user when a number of errors reaches a given threshold number of errors.

18. The method of claim 17, wherein notifying the user comprises:
a notification to the user to replace the target sensor.

19. The method of claim 17, wherein notifying the user comprises:
a notification to the user to re-calibrate the target sensor.

20. The method of claim 13, further comprising:
training the selected machine learning network using most recent real-time data, wherein older system data is removed from the training set as the more recent real-time data is received.
